(19) United States
(12) Patent Application Publication
(10) Pub. No.: US 2023/0151968 A1
(43) Pub. Date: May 18, 2023

(54) CONTROL UNIT AND METHOD FOR CONTROLLING A GAS-BASED COOKING APPLIANCE

(71) Applicant: BSH Hausgeraete GmbH, Munchen (DE)

(72) Inventors: Dogan Duman, Tekirdag (TR); Yusuf Kocaman, Tekirdag (TR)

(21) Appl. No.: 17/974,039

(22) Filed: Oct. 26, 2022

(30) Foreign Application Priority Data
Nov. 17, 2021 (TR) 2021/017877

(51) Int. Cl. F24C 3/12; F23N 1/00

(52) U.S. Cl. CPC F24C 3/128; F23N 1/002; F23N 2223/46; F23N 2241/08

(57) ABSTRACT

A control unit controls a gas-based cooking appliance having gas burners. The control unit is configured to determine user information regarding a user of the cooking appliance using an electronic user device of the user. Furthermore, the control unit is configured to control the cooking appliance in dependence of the user information.

### CROSS-REFERENCE TO RELATED APPLICATION

This application claims the priority, under 35 U.S.C. § 119, of Turkish Patent Application TR2021/017877, filed Nov. 17, 2021; the prior application is herewith incorporated by reference in its entirety.

### FIELD AND BACKGROUND OF THE INVENTION

The present document relates to a gas-based cooking appliance, such as a gas hob and/or a gas oven. In particular, the present document relates to a method and a control unit for controlling a gas-based cooking appliance.

A gas-based cooking appliance may be used within a household for cooking and/or for baking. The use of gas within a household may lead to safety issues, notably if the gas-based cooking appliance is left unattended.

The present document addresses the technical problem of increasing the safety and/or the comfort-of-use of a gas-based cooking appliance. The technical problem is solved by each of the independent claims. Preferred examples are described in the dependent claims.

### SUMMARY OF THE INVENTION

According to an aspect, a control unit for controlling a gas-based cooking appliance (such as a gas hob and/or a gas oven) is described. The control unit may at least partially be a control module of the cooking appliance. Alternatively, or in addition, the control unit may at least partially be external to and/or separate from the cooking appliance. In a preferred example, the control unit is a central unit (e.g., a server) which is separate from the cooking appliance. The central unit may be located within a data cloud.

The control unit is configured to determine user information regarding a user of the cooking appliance using an (e.g., using data provided by an) electronic user device (e.g., a smartphone and/or a smart wearable such as a smart watch) of the user. The user device may be configured to be carried around by the user. Furthermore, the user device may be configured to provide data regarding the user (notably the state and/or the position of the user). The user information may be determined based on the data which is provided by the user device. In particular, the user device may comprise one or more sensors (such as a position sensor and/or an inertial measurement unit and/or a health sensor (for capturing e.g., the blood pressure and/or the heat beat)), which are configured to sense measurement data. The measurement data and/or data derived therefrom may be provided by the user device to the control unit. The user information may be indicative of the state (notably the state of health) and/or the position of the user.

Furthermore, the control unit may be configured to control the cooking appliance in dependence of the user information. In particular, the control unit may be configured to turn off the cooking appliance and/or to turn off the gas supply to the cooking appliance in dependence of the user information. Alternatively, or in addition, the control unit may be configured to turn off a gas burner of the cooking appliance in dependence of the user information. Alternatively, or in addition, the control unit may be configured to open or close a gas supply valve of the cooking appliance in dependence of the user information.

Hence, a control unit is described, which is configured to (remote) control a gas-based cooking appliance based on user information that has been determined using the user device of the user (in particular using one or more sensors of the user device). By doing this, the safety and/or the comfort-of-use of the cooking appliance may be increased in an efficient and reliable manner.

The control unit may be configured to determine the state, in particular the state of health, of the user of the cooking appliance based on the user information. The cooking appliance may then be controlled in dependence of the state of the user. In particular, the control unit may be configured to determine or detect, based on the user information, that the user is unconscious. In reaction to this, the cooking appliance and/or the gas supply to the cooking appliance may be turned off, thereby further increasing the safety of the cooking appliance.

The user device may comprise one or more sensors configured to capture measurement data regarding the user, in particular regarding the state of health (e.g., the heartbeat, the blood pressure, etc.) of the user and/or the position of the user. As indicated above, the user device may contain a smart wearable, in particular a smart watch, carried by the user.

The user information may be dependent on the measurement data captured by the one or more sensors of the user device. In particular, the control unit may be configured to determine the user information based on the measurement data captured by the one or more sensors of the user device. As a result of this, the user information may be determined in an efficient and precise manner.

The control unit may be configured to determine distance information regarding the distance between the cooking appliance and the user device based on the user information. In particular, the distance information may be determined based on position data of a position sensor, in particular a global navigation satellite system (GNSS) sensor, of the user device. Alternatively, or in addition, the distance information may be determined based on radio data regarding the signal strength of a radio signal (e.g., a Bluetooth signal) emitted and/or captured by a wireless communication module of the user device.

The control unit may be configured to control the cooking appliance based on the distance information. In particular, the control unit may be configured to determine, based on the distance information, whether the distance between the cooking appliance and the user device is greater than a pre-determined distance threshold. The distance threshold may e.g., be in the range between 5 to 20 meters.

The control unit may be configured to turn off the cooking appliance and/or to turn off the gas supply to the cooking appliance, if it is determined that the distance between the cooking appliance and the user device is greater than the pre-determined distance threshold. By doing this, the safety of the cooking appliance may be further increased.

In particular, the control unit may be configured to send a notification to the user device, if it is determined that the distance between the cooking appliance and the user device is greater than the pre-determined distance threshold. Furthermore, the control unit may be configured to determine whether or not the notification is acknowledged by the user at the user device (within a predetermined time interval, of e.g., 10 seconds). The cooking appliance and/or the gas supply to the cooking appliance may be turned off, if it is determined that the notification is not acknowledged by the user. By doing this, the safety of the cooking appliance may be increased in a particularly comfortable manner.

As indicated above, the control unit may be a central unit (e.g., a server) which is separate from the cooking appliance and from the user device. The central unit may be configured to communicate with the user device via a wireless and/or wireline communication link (such as a LAN, WLAN, 3G, 4G or 5G communication link). Furthermore, the central unit may be configured to control the cooking appliance via a wireless and/or wireline communication link (such as a LAN, WLAN, 3G, 4G or 5G communication link). By making use of a central unit, the safety and/or the comfort-of-use of the cooking appliance may be increased in a particularly reliable manner.

The control unit may be configured to determine that a control element (e.g., knob) of the cooking appliance has been actuated to turn on a burner of the cooking appliance. Furthermore, the control unit may be configured to determine whether or not the actuation of the control element has been confirmed by the user via the user device (within a predetermined time interval). For this purpose, a confirmation request may be sent to the user device. The user may then reply to the confirmation request in order to confirm the actuation of the control element.

The control unit may be configured to turn on the burner, if it is determined that the actuation of the control element has been confirmed by the user via the user device. On the other hand, the control unit may be configured to prevent gas from being supplied to the burner (e.g., by maintain the supply valve closed), if it is determined that the actuation of the control element has not been confirmed by the user via the user device.

By allowing the user to confirm the activation of a burner of the cooking appliance via the electronic user device, the safety of the cooking appliance may be further increased.

The control unit may be configured to determine status information regarding the status of the cooking appliance. Example status information is the fact that a burner of the cooking appliance is being operated, the duration of the operation of the burner and/or the temperature of the flame which is produced by the burner. Furthermore, the control unit may be configured to provide the status information to the user device, thereby increasing the comfort-of-use of the cooking appliance.

According to another aspect, a method for controlling a gas-based cooking appliance (notably a gas hob) is described. The method includes determining user information regarding a user of the cooking appliance using an electronic user device of the user (in particular, using data provided by the user device of the user). Furthermore, the method includes controlling the cooking appliance in dependence of the user information.

It should be noted that the methods and systems including its preferred embodiments as outlined in the present document may be used stand-alone or in combination with the other methods and systems disclosed in this document. In addition, the features outlined in the context of a system are also applicable to a corresponding method. Furthermore, all aspects of the methods and systems outlined in the present document may be arbitrarily combined. In particular, the features of the claims may be combined with one another in an arbitrary manner.

Other features which are considered as characteristic for the invention are set forth in the appended claims.

Although the invention is illustrated and described herein as embodied in a control unit and a method for controlling a gas-based cooking appliance, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1A is an illustration showing an example system for controlling a gas-based cooking appliance;

FIG. 1B is a block diagram of an example user device; and

FIG. 2 is a flow chart of an example method for controlling a gas-based cooking appliance.

### DETAILED DESCRIPTION OF THE INVENTION

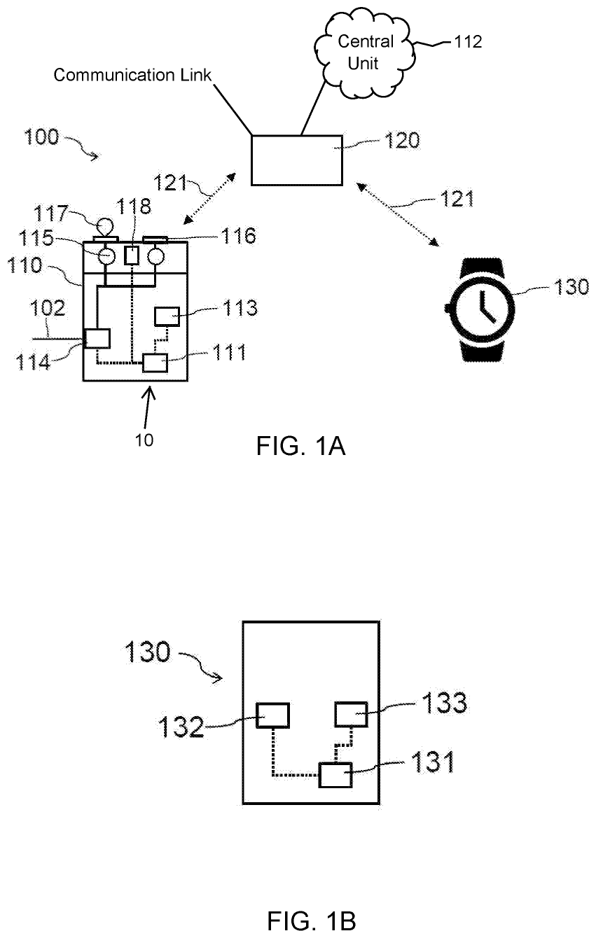

As outlined above, the present document is directed at increasing the safety and the comfort-of-use of a gas-based cooking appliance, such as a gas hob or a gas oven. Referring now to the figures of the drawings in detail and first, particularly to FIG. 1A thereof, there is shown an example system 100 containing a gas-based cooking appliance 10 which is communicatively coupled with a central unit 112, such as a server within a data cloud. The cooking appliance 10 and the central unit 112 may be configured to communicate via a wireless and/or a wireline data communication link 120, such as a local area network (LAN), a wireless local area network (WLAN), 3G, 4G and/or 5G. For this purpose, the cooking appliance 10 may comprise a communication unit 113.

The cooking appliance 10 has one or more burners 116 which are configured to burn gas which is provided via a supply line 102 to the cooking appliance 10. In FIG. 1A a flame 117 is illustrated at one of the burners 116. The cooking appliance 10 may have one or more (mechanical) control elements 115 which allow a user of the cooking appliance 10 to turn on or off and/or to adjust the gas supply to the burner 116.

The cooking appliance 10 has a control module 111 which is configured to control one or more components of the cooking appliance 10, in particular, in dependence of data received via the communication unit 113. Hence, the control module 111 may be configured to enable a remote control of the cooking appliance 10. The control module 111 may e.g., be configured to control a supply valve 114 of the cooking appliance 10, wherein the supply valve 114 may be closed to shut off the supply line 102 or may be opened to couple the cooking appliance 10 with the supply line 102. Hence, the supply valve 114 may be used to put the cooking appliance 10 into a safe state by closing the supply valve 114 in order to cut off the gas supply to the cooking appliance 10.

The system 100 may further have an electronic user device 130 which may be a smart watch as illustrated in FIG. 1A. The user device 130 may be carried by the user of the cooking appliance 10. The user device 130 may be configured to exchange data with the central unit 112 via a wireline and/or wireless communication link 121. As shown in FIG. 1B, the user device 130 may comprise a communication module 133 for this purpose. Furthermore, the user device 130 may comprise one or more sensors 132 which are configured to sense measurement data regarding the user of the user device 130. The measurement data may be indicative of:

the position of the user device 130 and of the user carrying the user device 130; and/or

the state of the user, notably with regards to the consciousness of the user.

The central unit 112 may be configured to determine user information regarding the user of the cooking appliance 10. The user information may be provided by the user device 130 via the communication link 120. The user information may be based on the measurement data of the one or more sensors 132 of the user device 130. In particular, the measurement data may have been processed by a control element 131 of the user device 130 to determine the user information and/or to determine data which is derived from the measurement data. The user information and/or the derived data and/or the measurement data may be provided by the user device 130 to the central unit 112 via the communication link 120 (using the communication module 133 of the user device 130).

Furthermore, the central unit 112 may be configured to control the cooking appliance 10 in dependence of the user information. In particular, the central unit 112 may be configured to put the cooking appliance 10 into a safe state, if the user information indicates that the user does not supervise the cooking appliance 10 and/or if the user information indicates that the user is not conscious (e.g., because the user is sleeping or because the user has a medical issue). For this purpose, the central unit 112 may send a control command to the control module 111 of the cooking appliance 10 via the communication link 120. The control module 111 of the cooking appliance 10 may then put the cooking appliance 10 into a safe state, e.g., by closing the supply valve 114.

Hence, the system 100 is described which allows a gas-based cooking appliance 10 to be coupled with a (mobile) user device 130 via a central unit 112, thereby allowing the cooking appliance 10 to be remote controlled. As a result of this, the safety and/or the comfort-of-use of the cooking appliance 10 may be increased.

The cooking appliance 10 may comprise one or more sensing elements 118 which are configured to measure appliance data regarding the cooking appliance 10. In particular, the sensing element 118 (such as a thermocouple sensor) may be configured to measure appliance data regarding a flame 117 which is produced by a burner 116 of the cooking appliance 10. In particular, the temperature of the flame 117 may be measured.

The control module 111 of the cooking appliance 10 may be configured to determine, based on the data measured by the one or more sensing element 118, that a flame 117 is produced by a burner 116 of the cooking appliance 10. If this the case, the supply valve 114 may be kept open. On the other hand, if it is determined that the control element 115 of the burner 116 has been turned to release gas, but that no flame 117 is being generated, the supply valve 114 may be closed to cut off the gas supply. The fact that no flame 117 is being generated may be determined based on the measured temperature.

Information regarding the operation of the cooking appliance 10 may be sent to the central unit 112. By way of example, the starting time of the operation of a burner 116 and/or the temperature of the flame 117 may be provided to and may possibly be stored by the central unit 112. The temperature of the flame 117 may be updated repeatedly during the operation of the burner 116. Furthermore, the duration of the operation of the burner 116 may be tracked by the central unit 112. If it is detected that the control element 115 is actuated for turning off the burner 116, the supply valve 114 may be closed to cut off the gas supply.

The user may be informed on the user device 130 about the status of the cooking appliance 10. In particular, the user may be informed on whether a burner 116 of the cooking appliance 10 is turned on or off. By way of example, a notification may be sent to the user device 130 in order to inform the user that a burner 116 of the cooking appliance 10 has been activated and/or is being operated. Such notifications may be sent repeatedly during operation of the burner 116. Furthermore, the user may be informed about the temperature of the flame 117 of the burner 116.

The control module 111 of the cooking appliance 10 and/or the central unit 112 may be configured to send a notification to the user device 130, if the activation and/or the use of the cooking appliance 10 is detected. As a result of this, an unexpected use of the cooking appliance 10 (e.g., by a child or by an elderly person may be detected). Alternatively, or in addition, the control module 111 of the cooking appliance 10 and/or the central unit 112 may be configured to send a notification to the user device 130, if it is detected that the flame 117 of a burner 116 has been blown out (e.g., by an external factor such as wind or boiling water).

Alternatively, or in addition, the control module 111 of the cooking appliance 10 and/or the central unit 112 may be configured to send information regarding the ambient temperature of the cooking appliance 10 and/or the flame temperature to the user device 130. As a result of this, the user may be informed about an abnormal situation within the vicinity of the cooking appliance 10, such as a fire or an open window.

Alternatively, or in addition, the control module 111 of the cooking appliance 10 and/or the central unit 112 may be configured to send information regarding the starting time and/or the duration of operation of a burner 116 of the cooking appliance 10 to the user device 130. This information may be sent to the user device 130 repeatedly in regular intervals. The time interval (e.g., every 15 or 30 minutes) between successive notifications may be set by the user.

The control module 111 of the cooking appliance 10 and/or the central unit 112 may be configured to determine whether or not the user has responded to a notification which has been provided to the user device 130. If it is determined that the user has not responded to a notification, the cooking appliance 10 may be turned off automatically, thereby increasing the safety of the cooking appliance 10.

The control module 111 of the cooking appliance 10 and/or the central unit 112 may be configured to receive a control command for controlling the cooking appliance 10 from the user device 130. The control command may be directed at turning off a burner 116 of the cooking appliance 10. The control module 111 of the cooking appliance 10 and/or the central unit 112 may be configured to control the cooking appliance 10 in dependence of the received control command, thereby enabling a remote control of the cooking appliance 10 using the user device 130, e.g., using a software appliance on the user device 130.

The user may be enabled to set a time for turning off the cooking appliance 10, e.g., a burner 116 of the cooking appliance 10, using the user device 130. The control module 111 of the cooking appliance 10 and/or the central unit 112 may be configured to automatically turn off the cooking appliance 10 at the time set by the user. The time may be set using a countdown or timer. Alternatively, or in addition, a maximum working time of the cooking appliance 10 may be set. Regardless of the use of the cooking appliance 10, the cooking appliance 10 may then be turned off automatically after the maximum working time has elapsed.

The control module 111 of the cooking appliance 10 and/or the central unit 112 may be configured to determine the distance between the user (i.e., the user device 130) and the cooking appliance 10, while the cooking appliance 10 is being operated. The location of the cooking appliance 10 may be stored within a database of the central unit 112. If the distance between the user and the cooking appliance 10 is equal to or greater than a pre-determined threshold distance, the user may be informed via the user device 130 that the cooking appliance 10 is being operated. Alternatively, or in addition, the cooking appliance 10 may be turned off automatically.

The user may be enabled to set one or more specific time intervals during a day, during which the cooking appliance 10 may be operated and/or may not be operated. By way of example, the use of the cooking appliance 10 may be blocked during night time. As a result of this, the safety of the cooking appliance 10 may be increased further.

The control module 111 of the cooking appliance 10 and/or the central unit 112 may be configured to verify whether or not the user has confirmed the activation of the cooking appliance 10, e.g., the activation of a burner 116 of the cooking appliance 10, on the user device 130. After turning on a burner 116 of the cooking appliance 10 using the control element 115, the control module 111 of the cooking appliance 10 and/or the central unit 112 may verify whether this activation at the cooking appliance 10 has been confirmed using the user device 130. There may be a maximum time (e.g., 10 seconds) for confirming an activation. If the activation is not confirmed, the gas supply may be blocked. Otherwise, the burner 116 may be activated. As a result of this, the safety of the cooking appliance 10 may be increased further.

The control module 111 of the cooking appliance 10 and/or the central unit 112 may be configured to log the usage of the cooking appliance 10 (e.g., the operation times and/or durations) within a database. The database may be accessible using the user device 130, thereby allowing the user to track the usage of the cooking appliance 10.

The control module 111 of the cooking appliance 10 and/or the central unit 112 may be configured to determine based on the data provided by the user device 130 (e.g., a smart watch) that the user is unconscious (e.g., due to a heart attack). In reaction to this, the cooking appliance 10 may be turned off automatically.

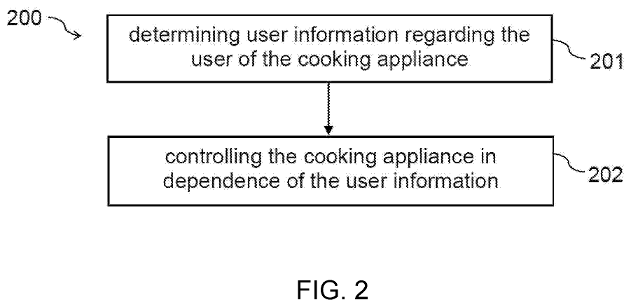

FIG. 2 shows a flow chart of an example (possibly computer-implemented) method 200 for controlling a gas-based cooking appliance 10. The method 200 may be executed by the central unit 112 which is separate from the cooking appliance 10 and/or from the electronic user device 130 of the user of the cooking appliance 10. Alternatively, or in addition, the method 200 may be executed by a control module 111 of the cooking appliance 10.

The method 200 includes determining 201 user information regarding the user of the cooking appliance 10. The user information is determined using the electronic user device 130 (in particular, a smart wearable) of the user. The user information may be indicative of the state and/or of the position of the user. The user information may be determined based on data, in particular measurement data captured by one or more sensors 132, that has been provided by the user device 130.

Furthermore, the method 200 includes controlling 202 the cooking appliance 10 in dependence of the user information, notably in dependence of the state of the user and/or of the position of the user. In particular, the cooking appliance 10 may be turned off automatically in dependence of the user information, in particular if the user information indicates that the user is unconscious and/or if the user information indicates that the user is too far away from the cooking appliance 10.

The measures which are described in the present document allow the safety and/or the comfort-of-use of a gas-based cooking appliance 10 to be increased.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiment outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

The following is a summary list of reference numerals and the corresponding structure used in the above description of the invention:
10 cooking appliance
100 system
102 supply line
110 control unit
111 control module
112 central unit
113 communication unit
114 supply valve
115 control element
116 burner
117 flame
118 sensing element
120 communication link
130 user device
131 control element
132 sensor
133 communication module

1. A system for controlling a gas-based cooking appliance, the system comprising:
an electronic user device for a user;
a controller configured to determine user information regarding the user of the gas-based cooking appliance using said electronic user device; and
said controller controlling the gas-based cooking appliance in dependence of the user information.

2. The system according to claim 1, wherein said controller is configured to:
determine a state of the user of the gas-based cooking appliance based on the user information; and
control the gas-based cooking appliance in dependence of the state of the user.

3. The system according to claim 1, wherein said controller is configured to determine, based on the user information, that the user is unconscious and in reaction to an unconscious user, turn off the gas-based cooking appliance and/or turn off a gas supply to the gas-based cooking appliance.

4. The system according to claim 1, wherein:
said electronic user device has at least one sensor configured to capture measurement data regarding the user; and
the user information is dependent on the measurement data captured by said at least one sensor of said electronic user device.

5. The system according to claim 1, wherein said electronic user device has a smart wearable carried by the user.

6. The system according to claim 1, wherein said controller is configured to:
determine distance information regarding a distance between the gas-based cooking appliance and said electronic user device based on the user information; and
control the gas-based cooking appliance based on the distance information.

7. The system according to claim 6, wherein said controller is configured to:
determine, based on the distance information, whether the distance between the gas-based cooking appliance and said electronic user device is greater than a pre-determined distance threshold; and
in reaction to the distance information being greater than the pre-determine distance threshold, turn off the gas-based cooking appliance and/or turn off a gas supply to the gas-based cooking appliance.

8. The system according to claim 7, wherein said controller is configured to:
send a notification to said electronic user device, if it is determined that the distance between the gas-based cooking appliance and said electronic user device is greater than the pre-determined distance threshold;
determine whether or not the notification is acknowledged by the user at said electronic user device; and
turn off the gas-based cooking appliance and/or turn off the gas supply to the gas-based cooking appliance, if it is determined that the notification is not acknowledged by the user.

9. The system according to claim 6, wherein:
said electronic user device has a position sensor and a wireless communication module;
the distance information is determined based on position data of said position sensor of said electronic user device, and/or radio data regarding a signal strength of a radio signal emitted and/or captured by said wireless communication module of said electronic user device.

10. The system according to claim 1, wherein said controller is configured to:
turn off the gas-based cooking appliance and/or turn off a gas supply to the gas-based cooking appliance in dependence of the user information; and/or
turn off a burner of the gas-based cooking appliance in dependence of the user information; and/or
open or close a supply valve of the gas-based cooking appliance in dependence of the user information.

11. The system according to claim 1, wherein:
said controller is a central unit which is separate from the gas-based cooking appliance and from said electronic user device;
said central unit is configured to communicate with said electronic user device via a wireless and/or wireline communication link; and
said central unit is configured to control the gas-based cooking appliance via the wireless and/or wireline communication link.

12. The system according to claim 1, wherein said controller is configured to:
determine that a control element of the gas-based cooking appliance has been actuated to turn on a burner of the gas-based cooking appliance;
determine whether or not an actuation of the control element has been confirmed by the user via said electronic user device;
turn on the burner, if it is determined that the actuation of the control element has been confirmed by the user via the user device; and/or
prevent gas from being supplied to the burner, if it is determined that the actuation of the control element has not been confirmed by the user via said electronic user device.

13. The system according to claim 1, wherein said controller is configured to:
determine status information regarding a status of the gas-based cooking appliance; and
provide the status information to the user device.

14. The system according to claim 1, wherein the gas-based cooking appliance has a gas hob and/or a gas oven.

15. The system according to claim 4, wherein the measurement data regards a state of health of the user.

16. The system according to claim 5, wherein said electronic user device is a smart watch.

17. The system according to claim 9, wherein said position sensor is a global navigation satellite system sensor.

18. A method for controlling a gas-based cooking appliance, which comprises the steps of:
determining user information regarding a user of the gas-based cooking appliance using an electronic user device of the user; and
controlling the gas-based cooking appliance in dependence of the user information.

19. A control unit for controlling a gas-based cooking appliance, the control unit comprising:
means for determining user information regarding a user of the gas-based cooking appliance using an electronic user device of the user; and
means for controlling the gas-based cooking appliance in dependence of the user information.
